(19) United States
(12) Patent Application Publication
(10) Pub. No.: US 2024/0392129 A1
(43) Pub. Date: Nov. 28, 2024

(54) FLUOROPOLYMER-FREE PROCESSING AIDS FOR ETHYLENE-BASED POLYMERS

(71) Applicant: ExxonMobil Chemical Patents Inc., Baytown, TX (US)

(72) Inventors: Nino RUOCCO, Houston, TX (US); Michael A. LEAF, Baytown, TX (US); Danny VAN HOYWEGHEN, Heverlee (BE)

(21) Appl. No.: 18/696,736

(22) PCT Filed: Sep. 27, 2022
(86) PCT No.: PCT/US2022/077081

§ 371 Date: Mar. 28, 2024

Related U.S. Application Data
(60) Provisional application No. 63/261,908, filed on Sep. 30, 2021.
(60) Provisional application No. 63/266,782, filed on Jan. 14, 2022.
(60) Provisional application No. 63/267,640, filed on Feb. 7, 2022.
(60) Provisional application No. 63/309,859, filed on Feb. 14, 2022.
(60) Provisional application No. 63/309,871, filed on Feb. 14, 2022.
(60) Provisional application No. 63/366,678, filed on Jun. 20, 2022.
(60) Provisional application No. 63/367,241, filed on Jun. 29, 2022.
(60) Provisional application No. 63/367,425, filed on Jun. 30, 2022.
(60) Provisional application No. 63/374,858, filed on Sep. 7, 2022.

(51) Int. Cl. C08L 71/02; C08L 23/08; C08L 67/08

(52) U.S. Cl. CPC C08L 71/02; C08L 23/0815; C08L 67/08; C08L 2205/06; C08L 2310/00

(57) ABSTRACT

Provided herein are polymer compositions comprising a Ziegler Natta-catalyzed polymer and polymer processing aid (PPA) compositions. The PPA composition comprises a polyethylene glycol, and optionally a sorbitan ester or polysorbate. The polyethylene glycol can have molecular weight less than 40,000 g/mol. The polymer can have melt index ratio (MIR) of 20 or greater. The polymer composition is preferably free or substantially free of fluorine, including fluoropolymer-based PPAs.

### CROSS-REFERENCE TO RELATED APPLICATION

This application claims the benefit of U.S. Provisional Application 63/261,908 filed Sep. 30, 2021 entitled “Fluorine-Free Polymer Processing Aids”, and also claims the benefit of U.S. Provisional Application 63/266,782 filed Jan. 14, 2022 entitled “Fluorine-Free Polymer Processing Aids”, and also claims the benefit of U.S. Provisional Application 63/267,640 filed Feb. 7, 2022 entitled “Fluorine-Free Polymer Processing Aids Including Polyethylene Glycols”, and also claims the benefit of U.S. Provisional Application 63/309,859 filed Feb. 14, 2022 entitled “Fluorine-Free Polymer Processing Aids Including Polyethylene Glycols”, and also claims the benefit of U.S. Provisional Application 63/309,871 filed Feb. 14, 2022 entitled “Fluorine-Free Polymer Processing Aid Blends”, and also claims the benefit of U.S. Provisional Application 63/366,678 filed Jun. 20, 2022 entitled “Fluorine-Free Polymer Processing Aid Blends”, and also claims the benefit of U.S. Provisional Application 63/367,241 filed Jun. 29, 2022 entitled “Polyethylene Glycol-Based Polymer Processing Aids”, and also claims the benefit of U.S. Provisional Application 63/367,425 filed Jun. 30, 2022 entitled “Polyethylene Glycol-Based Polymer Processing Aid Masterbatches”, and also claims the benefit of U.S. Provisional Application 63/374,858 filed Sep. 7, 2022 entitled “Fluoropolymer-Free Processing Aids for Ethylene-Based Polymers”, the entireties of which are incorporated by reference herein.

### FIELD

The present disclosure relates to additives for polyolefin polymers (such as polyethylene), as well as the polymers themselves, methods of making them, and articles made therefrom.

### BACKGROUND

Polyolefin polymer compositions are in high demand for many applications, including various films (such as cast films, shrink films, and blown films), sheets, membranes such as geomembranes, sacks, pipes (e.g., polyethylene of raised temperature (PE-RT) pipes, utility pipes, and gas distribution pipes), roto-molded parts, blow-molded flexible bottles or other containers, and various other blow molded/extruded articles such as bottles, drums, jars, and other containers. These applications have been commonly made from, for example, polyethylene polymers.

Polyolefin polymers are most commonly produced and sold as pellets, formed in post-polymerization reactor finishing processes (such as extrusion of polymer product that is in an at least partially molten state, followed by pelletization). Additives are commonly blended into the polymer product as part of this finishing process, such that the polymer pellets comprise the polymer itself and one or more additives.

Common additives, particularly for polymers such as polyethylenes intended for use as films, sacks, and other similar articles, include polymer processing aids (PPAs), which help make the pellets easier to manipulate in downstream manufacturing processes (such as extrusion, rolling, blowing, casting, and the like). Adequate amounts of PPA, among other things, help eliminate melt fractures in films made from the polymer pellets. This is particularly so for polymer pellets exhibiting relatively higher viscosity in extrusion processes. Melt fracture is a mechanically-induced melt flow instability which occurs, e.g., at the exit of an extrusion die and typically in conditions of high shear rate. Pinhole, linear, and annular die geometries are among those that can induce melt fracture. There are different mechanical regimes that describe PE melt fracture, but all manifest as a very rough polymer surface which persists as the polymer crystallizes. Commonly in the blown film industry, a rough array of sharkskin like patterns develop on the film surface, often with a characteristic size from the mm to cm scale, and they depend on both the flow profile and rheology of the polyolefin polymer (e.g., polyethylene).

Melt fracture can adversely affect film properties, distort clarity, and reduce gauge uniformity. Thus, melt fracture-prone polymer grades, as noted, often rely on a PPA.

The most common PPAs are or include fluoropolymers (fluorine-containing polymers). It is, however, desired to find alternative PPAs that do not include fluoropolymers and/or fluorine, while maintaining or even surpassing the effectiveness of the incumbent fluoropolymer-based PPAs in preventing melt fractures.

Some references of potential interest in this regard include: U.S. Pat. Nos. 10,982,079; 10,242,769; 10,544,293; 9,896,575; 9,187,629; 9,115,274; 8,552,136; 8,455,580; 8,728,370; 8,388,868; 8,178,479; 7,528,185; 7,442,742; 6,294,604; 5,015,693; and 4,540,538; U.S. Patent Publication Nos. 2005/0070644, 2008/0132654, 2014/0182882, 2014/0242314, 2015/0175785, 2017/0342245, 2020/0325314; as well as WO2022/076296; WO2022/079601; WO2020/146351; WO2011/028206, CN104558751, CN112029173, KR10-2020-0053903, CN110317383, JP2012009754A, WO2017/077455, CN108481855, CN103772789.

### SUMMARY

The present disclosure relates to polymer compositions, their methods of manufacture, and articles including and/or made from the polymer compositions. In a particular focus, the polymer compositions may be polyolefin compositions, such as polyethylene compositions. The polymer compositions can also include a PPA that is free or substantially free of fluorine; and, similarly, the polymer compositions can be free or substantially free of fluorine. In this context, “substantially free” permits trace amounts (e.g., 10 ppm or less, preferably 1 ppm or less, such as 0.1 ppm or less) of fluorine, e.g., as an impurity, but well below the amount that would intentionally be included in a polymer composition via such additives (e.g., about 100 ppm of fluorine atoms by mass of polymer product in a typical case where such additives are included). In various embodiments, the polymer compositions can be, e.g., polymer pellets; a polymer melt (as would be formed in an extruder such as a compounding extruder); reactor-grade polymer granules and/or polymer slurries; or other form of polymer composition containing the PPA and optionally one or more other additives.

The present disclosure also relates to films and/or other end-use articles made from such polymer compositions, and in particular instances can relate to cast or blown films, preferably blown films. Thus, the polyolefin compositions (e.g., polymer pellets) of various embodiments, and/or films or other articles made therefrom (e.g., blown films), are themselves free or substantially free of fluorine (or, at a minimum, free or substantially free of fluorine-based PPA). A fluorine-based PPA, as used herein, is a polymer processing aid or other polymeric additive containing fluorine in any form (including, e.g., in fluoropolymers).

The present inventors have found that, although many potentially useful compositions for alternative PPAs are promising across various types of ethylene polymers, for Ziegler-Natta catalyzed polyethylene, a polyethylene glycol (PEG)-based PPA and in particular a PPA comprising a blend of PEG and a surfactant such as a sorbitan ester or polysorbate, is substantially more effective than other prospective PPA blends. Furthermore, such PPAs can provide equivalent or superior performance as compared to their fluorine-containing counterparts. This is especially so for ethylene homopolymers and copolymers made using Ziegler-Natta catalysts. Such polymers typically have relatively broad molecular weight distribution and, for copolymers, have a comonomer distribution such that shorter chains within the polymer composition have relatively greater amounts of comonomer incorporated thereon, while longer polymer chains have relatively little comonomer incorporation thereon. More particularly, the Ziegler-Natta catalyzed ethylene homopolymers and/or copolymers suitable for use with the PPA compositions herein can have one or more of the following characteristics: melt index ratio (MIR, the ratio of high load melt index (HLMI, 190° C. and 21.6 kg loading) to melt index (MI, 190° C. and 2.16 kg loading)) of 20 or greater, such as 25 or greater; MI of 5.0 g/10 min or less, such as 2.5 g/10 min or less, or 1.5 g/10 min or less, such as 0.1, 0.25 or 0.5 g/10 min to 1.5 or 2.5 g/10 min; and/or molecular weight distribution (ratio of weigh-average molecular weight, Mw, to number-average molecular weight, Mn) within the range from 3.5 to 7.5.

The preferred PPA compositions comprise PEG, preferably PEG having molecular weight less than 40,000 g/mol, such as within the range from 1,500 to 35,000 g/mol, such as 5,000 to 12,000 g/mol, or 5,000 to 20,000 g/mol. Most preferably, the PPA further comprises an additional surfactant such as a sorbitan ester or polysorbate, such as polysorbate 20, polysorbate 40, polysorbate 60, polysorbate 80, or combinations thereof. The PEG and additional surfactant, where present, can be present in the PPA composition in ratios (PEG:additional surfactant) within the range from 20:80 to 80:20, preferably 30:70 to 70:30, such as about 2:1, about 1:1, or about 1:2.

It is further found that an additional PPA blend partner such as metal salts of fatty acids can provide an additional benefit of increasing melting point of the PPA composition (as compared to a PPA composition having only PEG), making handling of the composition easier. Also or instead, a PPA masterbatch may be utilized, for instance, to ease handling (e.g., comprising a carrier resin, PEG, and optionally surfactant such as sorbitan ester or polysorbate).

The PPA composition can be present in the polymer composition in amounts ranging from about 300 ppm to about 15000 ppm, on the basis of mass of polymer in the polymer composition, more preferably about 300 ppm to about 2000 ppm, or about 500 ppm to about 1200 ppm. The foregoing amounts are on the basis of total mass of polymer plus PPA plus any other additives employed with the polymer. As noted, other additives optionally can also be present in the polymer composition (e.g., antioxidants, stabilizers such as UV stabilizers, catalyst neutralizers, and other additives known in the art of polymerization).

### BRIEF DESCRIPTION OF THE DRAWINGS

FIG. 1 is a schematic conceptually illustrating streaks of melt fractures and stripes of regions with melt fractures eliminated in a blown film during extrusion.

FIG. 2 is a graph showing the observed melt fracture % over time for certain trial films produced using various PPA compositions in connection with the examples.

FIG. 3 is a graph showing the observed melt fracture % over time for other trial films produced using various PPA compositions in connection with the examples.

FIG. 4 is a graph showing the observed melt fracture % over time for further trial films produced using various PPA compositions in connection with the examples.

FIG. 5 is a graph showing the observed melt fracture % over time for yet further trial films produced using various PPA compositions in connection with the examples.

### DETAILED DESCRIPTION

### Definitions

For the purposes of the present disclosure, various terms are defined as follows.

The term “polyethylene” refers to a polymer having at least 50 wt % ethylene-derived units, such as at least 70 wt % ethylene-derived units, such as at least 80 wt % ethylene-derived units, such as at least 90 wt % ethylene-derived units, or at least 95 wt % ethylene-derived units, or 100 wt % ethylene-derived units. The polyethylene can thus be a homopolymer or a copolymer, including a terpolymer, having one or more other monomeric units. A polyethylene described herein can, for example, include at least one or more other olefin(s) and/or comonomer(s).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically.

The term “alpha-olefin” or “α-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group. For the purposes of the present disclosure, ethylene shall be considered an α-olefin.

As used herein, the term “extruding” and grammatical variations thereof refer to processes that include forming a polymer and/or polymer blend into a melt, such as by heating and/or sheer forces, and then forcing the melt out of a die in a form or shape such as in a film, or in strands that are pelletized. Most any type of apparatus will be appropriate to effect extrusion such as a single or twin-screw extruder, or other melt-blending device as is known in the art and that can be fitted with a suitable die. It will also be appreciated that extrusion can take place as part of a polymerization process (in particular, in the finishing portion of such process) as part of forming polymer product (such as polymer pellets); or it can take place as part of the process for forming articles such as films from the polymer pellets (e.g., by at least partially melting the pellets and extruding through a die to form a sheet, especially when combined with blowing air such as in a blown film formation process). In the context of the present disclosure, extrusion in the finishing portion of polymerization processes may be referred to as compounding extrusion, and typically involves feeding additives plus additive-free (reactor grade) polymer to the extruder; while extrusion of polymer to make articles (e.g., extrusion of polymer pellets to make films) takes place conceptually “downstream” (e.g., at a later point, after polymer product has been formed including through compounding extrusion), and typically involves feeding optional additives plus additive-containing polymer to the extruder.

“Finishing” as used herein with reference to a polymerization process refers to post-polymerization reactor processing steps taken to form a finished polymer product, such as polymer pellets, with one example of a finishing process being the compounding extrusion just discussed. As the ordinarily skilled artisan will recognize, finishing is distinguished from, and conceptually takes place antecedent to, further processing of the finished polymer product into articles such as films.

A “PEG-based PPA composition” is a polymer processing aid composition containing at least 20 wt % polyethylene glycol (on basis of the total mass of the PPA composition).

A “polymer composition” refers to a composition containing a polymer. The polymer composition can be in any form. Some examples include: the form of a reactor grade (e.g., granules) containing the polymer; the form of a molten or at least partially molten composition containing the polymer and one or more additives undergoing or about to be undergoing the process of finishing (such as in the process of compounding extrusion and/or pelletization), which may be referred to as a pre-finished polymer composition; in the form of a finished polymer product such as polymer pellets containing the polymer and any additives (such as PPA); or in the form of a finished polymer product such as polymer pellets undergoing the process of mixing (e.g., via coextrusion, melt blending, or other processing) with additives, such as in the case of polymer being extruded to form film or other polymer-containing article.

### Polymers

In various embodiments, polymer compositions include one or more Ziegler-Natta catalyzed polymers, especially ethylene-based homopolymers and/or copolymers. Such polymers can be produced in any known process for catalyzed polymerization, such as slurry phase, gas phase, or solution phase, all of which are well known in the art of polymerization and not discussed further herein. Where a more highly linear ethylene homopolymer is produced (e.g., using gas or slurry phase polymerization with any of the above noted catalysts), it may be referred to as HDPE (high density polyethylene), typically having density 0.945 g/cm³ or greater, such as within the range from 0.945 to 0.970 g/cm³. Where comonomer is employed, ethylene-based copolymer is produced. Some ethylene-based copolymers also have higher density (e.g., as high as 0.970 g/cm³), but greater comonomer content typically results in lower density. Thus, such copolymers maybe referred to as linear low density PE (LLDPE), typically having density less than 0.945 g/cm³, such as within the range from 0.890 g/cm³ to less than 0.945 g/cm³, such as 0.900 or 0.910 g/cm³ to 0.930 or 0.935 g/cm³. Unless otherwise noted herein, all polymer density values are determined per ASTM D1505. Samples are molded under ASTM D4703-10a, procedure C, and conditioned under ASTM D618-08 (23°±2° C. and 50±10% relative humidity) for 40 hours before testing.

Particular examples contemplated herein include copolymers of ethylene and one or more C₃ to C₂₀ α-olefin comonomers, such as C₄ to C₁₂ α-olefin comonomers (with 1-butene, 1-hexene, 1-octene, or mixtures of two or more of them being preferred in various embodiments, and 1-butene being particularly preferred in certain embodiments). An ethylene copolymer (e.g., a copolymer of ethylene and one or more C₃ to C₂₀ α-olefins) can include ethylene-derived units in an amount of at least 80 wt %, or 85 wt %, such as at least 90, 93, 94, 95, or 96 wt % (for instance, in a range from a low of 80, 85, 90, 91, 92, 93, 94, 95, 96, or 97 wt %, to a high of 94, 95, 95.5, 96, 96.5, 97, 97.5, 98, 99, or 99.5 wt %, with ranges from any foregoing low value to any foregoing high value contemplated (provided the high is greater than the low) based on a total amount of ethylene-derived units and comonomer-derived units. For instance, the ethylene copolymer can include 94 or 95 wt % to 97 or 98 wt % ethylene-derived units based on the total amount of ethylene-derived units and comonomer-derived units. The balance of the copolymer (on the basis of ethylene-derived units and comonomer-derived units) is comprised of the comonomer-derived units. For example, comonomer units (e.g., C₃ to C₂₀ α-olefin-derived units, such as units derived from 1-butene, 1-hexene, and/or 1-octene) may be present in the ethylene copolymer from a low of 2, 2.5, 3, 3.5, 4, 4.5, 5, or 6 wt %, to a high of 3, 4, 5, 6, 7, 8, 9, 10, 15, or 20 wt %, with ranges from any foregoing low to any foregoing high contemplated (provided the high is greater than the low value).

In various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as 1-butene, 1-hexene, 1-octene as already noted), and α-olefins having one or more C₁-C₃ alkyl branches, or an aryl group. Examples can include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

A particular example of an ethylene-based polymer for use in the present disclosure is a linear-low density polyethylene (LLDPE), a copolymer of ethylene and one or more α-olefins polymerized in the presence of one or more single-site catalysts, such as one or more Ziegler-Natta catalysts. Such LLDPE can have density within the range from a low of 0.900, 0.905, 0.907, 0.910 g/cm³ to a high of 0.920, 0.925, 0.930, 0.935, 0.940, or 0.945 g/cm³.

Also or instead, density of the polymer may in various embodiments more broadly be within the range from 0.905 to 0.970 g/cm³, such as within the range from a low of any one of 0.905, 0.907, 0.908, 0.910, 0.911, 0.912, 0.913, 0.914, or 0.915 g/cm³ to a high of any one of 0.916, 0.917, 0.918, 0.919, 0.920, 0.924, 0.926, 0.930, 0.935, 0.940, 0.945, 0.950, 0.955, 0.960, 0.965, or 0.970 g/cm³, with ranges from any foregoing low to any foregoing high contemplated herein (e.g., 0.910 to 0.925 or 0.935 g/cm³, such as 0.912 to 0.925, or 0.915 to 0.918 g/cm³).

Further, the rheology characteristics of the polymer may influence the preferred PPA composition to be employed in the polymer composition to form a finished polymer product. In general, a PPA composition is preferably employed in a polymer having melt index (MI, or I₂, determined per ASTM D1238 at 190° C., 2.16 kg loading) of 5.0 g/10 min or less, preferably 2.5 g/10 min or less, such as within the range from 0.1, 0.2, 0.5, or 0.7 g/10 min to 1.0, 1.2, 1.5, 2.0, 2.5, 3.0, 4.0, or 5.0 g/10 min (with ranges from any low to any high contemplated, such as 0.5 or 0.7 g/10 min to 1.2 or 1.5 g/10 min). High load melt index (HLMI, 190° C., 21.6 kg loading, per ASTM D1238) can be within the range from 10, 15, 20, or 25 to 40, 50, 60, 65, 70, 75, or 80 g/10 min. Melt index ratio (MIR) is another polymer characteristic of potential interest in this regard. MIR is herein defined as the ratio HLMI/MI. Polymers of some embodiments can have MIR of 20 or higher, preferably 25 or higher, such as within the range from 20, 21, 22, 23, 24, or 25 to 27, 30, 32, 35, 37, 40, 45, 50, 60, 65, 70, 75, 80, 85, 90, 95, or 100.

Furthermore, such polymers, when in the form of copolymers, optionally can have a broad composition distribution, sometimes referred to as having a high composition distribution breadth index (CDBI), such as greater than 50%, or greater than 60%; also referred to as heterogeneously branched. In addition to these branching index references, it is noted that Ziegler-Natta catalyzed polyethylene copolymers are known to have a conventional comonomer distribution, meaning that within the polymer composition (having polymer chains of varying lengths), more comonomer is incorporated onto relatively shorter polymer chains, and less comonomer is incorporated onto longer polymer chains. In this way, Ziegler-Natta catalyzed polymers are distinguished from some other copolymers referred to as having a “broad orthogonal composition distribution” or “BOCD”, wherein the “orthogonal” references the reverse of the Ziegler Natta incorporation pattern: while such “BOCD” polymers involve greater comonomer incorporation on longer polymer chains, Ziegler-Natta polymers have greater comonomer incorporation on shorter polymer chains. See, e.g., ¶ [0022] and FIG. 7 of WO 2008/002524, which description is incorporated herein by reference.

The polymers may also have molecular weight distribution (MWD, or ratio of weight-average molecular weight, Mw, to number-average molecular weight, Mn, both determined per conventional IR-based measurements) within the range from 3.5, 3.75, or 4.0 to 6.0, 6.5, 7.0, or 7.5. See ¶¶ [0158]-[0159] of WO2020/046900 for description of determining the conventional molecular weight (IR MW) values, with reference to linear ethylene polymers for adjusting the polystyrene standards set out therein.

The PEG-including PPA compositions are discussed in more detail below.

### PEG-Including Polymer Processing Aids and Suitable PEGs

The polymer compositions, as noted, also include a PPA composition. The PPA composition of some embodiments can comprise at least 20 wt % PEG, such as at least 30 wt % or at least 40 wt % PEG. In particular embodiments, the PPA composition can consist of or consist essentially of PEG (where “consist essentially of”, in this context, permits up to 1 wt %, more preferably 0.5 wt % or less, most preferably 0.1 wt % or less, of impurities, where the impurities preferably do not include fluorine or any fluorine-containing compound). In other embodiments, the PPA composition can further comprise an additional surfactant such as a sorbitan ester or polysorbate, preferably in amounts from a low of 20, 25, 30, 35, 40, or 45 wt % to a high of 35, 40, 45, 50, 55, 60, 65, 70, 75, or 80 wt %, with ranges from any foregoing low to any foregoing high contemplated herein, provided the high is greater than the low (e.g., 30 to 45 wt %, or 40 to 60 wt %, or 45 to 55 wt %). The one or more PEGs may form the balance of the PPA composition. Put more generally, where PEG and sorbitan ester or polysorbate blends are employed as the PPA composition, the PEG and sorbitan ester or polysorbate may be present in weight ratios (PEG:sorbitan ester or polysorbate) within the range from 1:5 to 5:1; such as 20:80 to 80:20, 30:70 to 70:30, or 40:60 to 60:40, or 45:55 to 55:45.

It is noted that PEG is a component in some known fluoropolymer-based PPAs (see, e.g., WO2020/146351) and higher-molecular weight PEG (often referred to as polyethylene oxide or PEO, see below for more details) has been suggested as one among other ingredients such as metal salts of particular acids or alkylsulfate, in other PPAs (see, e.g., US2017/0342245). However, the present inventors have found particular lower molecular weight varieties of polyethylene glycol are useful as PPAs, and for most polymers, the PEG can be deployed on its own or with substantially different other components, especially without fluorine-based components and/or inorganic components such as the aforementioned metal salts.

As used herein, polyethylene glycol or PEG refers to a polymer expressed as H—(O—CH₂—CH₂)ₙ—OH, where n represents the number of times the O—CH₂—CH₂ (oxyethylene) moiety is repeated; n can range widely, because PEG comes in a wide variety of molecular weights. For instance, n can be about 33 for lower-molecular weight polyethylene glycols (˜1500 g/mol), ranging up to about 227 for higher molecular weight polyethylene glycols (˜10,000 g/mol) such as about 454 for ˜20,000 g/mol molecular-weight PEG; and 908 for ˜40,000 molecular-weight PEG; and even higher for higher-molecular-weight PEG varieties.

It is also noted that PEG can equivalently be referred to as polyethylene oxide (PEO) or polyoxyethylene (POE). Sometimes in industry parlance, PEG is the nomenclature used for relatively lower molecular weight varieties (e.g., molecular weight 20,000 g/mol or less), while polyethylene oxide or PEO is used for higher-molecular-weight varieties (e.g., above 20,000 g/mol). However, for purposes of the present application, references to polyethylene glycol or PEG should not, alone, be taken to imply a particular molecular weight range, except where a molecular weight range is explicitly stated. That is, the present application may use the terms polyethylene glycol or PEG to refer to a polymer having structure H—(O—CH₂—CH₂)ₙ—OH with n such that the polymer's molecular weight is less than 20,000 g/mol, and it may also use the terms polyethylene glycol or PEG to refer to such a polymer with n such that the polymer's molecular weight is greater than 20,000 g/mol, such as within the range from 20,000 to 40,000 g/mol.

PEG “molecular weight” as used herein refers to weight-average molecular weight (Mw) as determined by gel permeation chromatography (GPC), as described below. It is also noted that many commercial PEG compounds include a nominal molecular weight (e.g., “PEG 3K” or “PEG 10K” indicating nominal 3,000 g/mol and 10,000 g/mol molecular weights, respectively). Unless otherwise noted, such molecular weights should be assumed to be weight-average molecular weight, although it is noted that many commercial PEG compounds have Mw/Mn values close to 1, such that number-average molecular weight (Mn) may be roughly equivalent to Mw. Regardless, Mw of the PEG should control over any contrary nominal indicator.

Polyethylene glycols suitable for use in PPAs herein generally can include PEG of a variety of molecular weights, potentially including PEG having Mw ranging from as low as 500 g/mol to as high as 200,000 g/mol, such as from a low of any one of 500, 600, 700, 800, 900, 1000, 3000, 5000, 7000, or 7500 g/mol to a high of 40000, 50000, 60000, 75000, 80000, 90000, 100000, 125000, 150000, 175000, or 200000 g/mol, with ranges from any low end to any high end contemplated.

In certain embodiments, however, particularly preferred PEGs are those having molecular weight less than 40,000 g/mol; such as within the range from a low of any one of 500, 600, 700, 800, 900, 1000, 1500, 2000, 2500, 3000, 3500, 4000, 4500, 5000, 5500, 6000, 7000, 8000, 8500, 9000, 9500, 10000, 12500, and 15000 g/mol to a high of any one of 7000, 7500, 8000, 8500, 9000, 9500, 10000, 10500, 11000, 11500, 12000, 12500, 15000, 20000, 22000, 25000, 30000, 35000, 39000, and 39500 g/mol, provided the high end is greater than the low end, and with ranges from any foregoing low end to any foregoing high end generally contemplated (e.g., 1,500 to 35,000 g/mol, or 5,000 to 20,000 g/mol, such as 5,000 to 12,000 g/mol or 6,000 to 12,000 g/mol). Particular higher or lower sub-ranges may also be suitable (e.g., PEG having Mw of 1,500 to 5,500 g/mol; or PEG having Mw of 5,000 to 12,000 g/mol; or PEG having Mw of 10,000 to 20,000 g/mol; or PEG having Mw of 15,000 to 25,000 g/mol; or PEG having Mw of 25,000 to 35,000 g/mol).

Further, it is also contemplated that blends of multiple of the aforementioned PEG compounds could form a suitable PPA, preferably wherein all PEG compounds of such blend have Mw 40,000 g/mol or less. That is, it is preferred that all or substantially all polyethylene glycol of the polymer compositions has molecular weight less than 40,000 g/mol; such as less than 35,000 g/mol, or less than 33,000 g/mol, or less than 22,500 g/mol, or less than 20,000 g/mol, or less than 12,000 g/mol, such as less than 10,000 g/mol. In this context, “substantially all” means that minor amounts (50 ppm or less, more preferably 10 ppm or less, such as 1 ppm or less) of higher-molecular weight PEG could be included while not losing the effect of including predominantly the lower-molecular-weight PEGs described herein. Put equivalently, the PEG having molecular weight greater than 40,000 g/mol is absent or substantially absent from the polymer compositions. It is believed that the focus on lower molecular-weight PEG enables generally lower loadings of the PEG-based PPA to achieve the desired elimination of melt fractures across most grades of polymer that might experience melt fracture when formed into blown films. Similarly, lower molecular-weight PEG is believed to diffuse faster to the surface of polymer material being extruded in, e.g., blown film processes, as compared to higher molecular weight varieties of PEG; therefore, the lower molecular-weight PEG varieties will typically lead to faster elimination of melt fracture in blown films (and therefore lower off-spec production). However, it is nonetheless contemplated that higher-molecular weight PEG (e.g., Mw>40,000 g/mol) may be appropriate in some cases for certain polymer grades, despite the above-noted advantages of lower-molecular weight PEG; hence the contemplation that such higher-molecular weight PEGs may be included in polymer compositions that are still within the spirit and scope of some embodiments of the present invention.

Commercially available examples of suitable polyethylene glycols, especially those of lower molecular weight, include Pluriol® E 1500; Pluriol® E 3400; Pluriol® E 4000; Pluriol® E 6000; Pluriol® E 8000; and Pluriol® E 9000 polyethylene glycols available from BASF (where the numbers represent nominal molecular weights of the PEG); and also include Carbowax™ 8000, Carbowax™ Sentry™ 8000 NF EP available from Dow.

Unless otherwise indicated, the distribution and the moments of molecular weight for PEG are determined by using Agilent 1260 Infinity II Multi-Detector GPC/SEC System equipped with multiple in-series connected detectors including a differential refractive index (DRI) detector, a viscometer detector, a two-angle light scattering (LS) detector and a UV diode array detector. Two Agilent PLgel 5-μm Mixed-C columns plus a guard column are used to provide polymer separation. THF solvent from Sigma-Aldrich or equivalent with 250 ppm of antioxidant butylated hydroxytoluene (BHT) is used as the mobile phase. The nominal flow rate is 1.0 ml/min and the nominal injection volume is 25 μL. The whole system including columns, detectors and tubings operates at 40° C. The column calibration was performed by using twenty-three polystyrene narrow standards ranging from 200 to 4,000,000 g/mole.

The Agilent Multi-Detector GPC Data Analysis Software is used to process data from any combination of DRI, light scattering and viscometer detectors to obtain information about polymer properties. Here, the light scattering MW is calculated by combining the concentration measured by DRI and the Rayleigh ratio measured by LS in each elution volume slice plus the detector calibration constants and polymer parameters such as refractive index increment (dn/dc). For the poly (ethylene glycol) samples used in the patent, the dn/dc is determined to be around 0.07 ml/g in THF solvent.

### Surfactant Blend Components

As noted, the PPA can preferably further include a surfactant with the PEG, such as a sorbitan ester or polysorbate. Most generally, suitable surfactants comprise a hydrophilic head and a lipophilic tail. As used herein, a hydrophilic head refers to a moiety having a polar, or hydrophilic, nature; and a lipophilic tail refers to a moiety, having an apolar, or lipophilic (alternatively, hydrophobic) nature. A lipophilic tail is so-named because it typically comprises a hydrocarbon chain of at least 3, 4, or 5 carbons in length. The heads and tails of surfactants can be composed of many different types and sizes of molecules, which are often adjusted to tune their solubility. Surfactants are a suitable option as a PPA blend component because they can be adjusted for their solubility in a polymer melt (e.g., melt polyethylene polymer); they can be apolar enough to be homogenized into the polymer of the melt, but polar enough to tend to migrate to metallic surfaces through which the melt is being passed, to form lubricating coatings.

One class of surfactants that gains particular focus herein is sorbitan esters, comprising an apolar carboxylic acid (a “lipophilic tail”) attached by ester linkage to a polar sorbitan group (the “hydrophilic head” of such molecules). Also of interest are polyoxyethylene derivatives of sorbitan esters, which include a plurality of polyoxyethylene oligomers chemically substituted onto the sorbitan group. These polyoxyethylene derivatives of sorbitan esters may also be referred to as polysorbates.

More particularly, the polyoxyethylene derivative of sorbitan ester (also referred to as a polysorbate) can take the form of Formula (I):

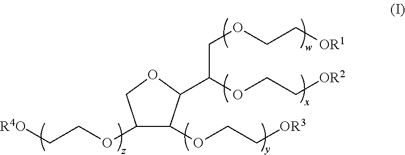

where: one of R¹-R⁴ is a straight chain fatty acid moiety, and the other three of R¹-R⁴ are each hydrogen; and w, x, y, and z are integers such that 10≤w+x+y+z≤40; preferably 15≤w+x+y+z≤25; more preferably w+x+y+z=20. The straight chain fatty acid moiety is preferably of the formula (C═O)(CH₂)ₐCH₃, where a is an integer between 10 and 25 (inclusive), preferably between 12 and 18 (inclusive), although the fatty acid moiety may instead include a double-bond along the hydrocarbon chain (that is, it may include a monounsaturation), such that the formula is (C═O)(CH₂)_{b}(CH)═(CH)(CH₂)_{c}CH₃, where b and c are each integers and b+c add to an integer between 8 and 23 (inclusive), preferably between 10 and 16 (inclusive). The skilled artisan will further recognize that the hydrocarbon chain may include two or more unsaturations in alternate embodiments, although it is preferred to maintain unsaturations at 4 or less, more preferably 3 or less, most preferably 0, 1, or 2 (e.g., to minimize potential for oxidation of the surfactant, thereby maximizing thermal stability).

Specific examples of polysorbates include polysorbate 20 (polyoxyethylene (20) sorbitan monolaurate); polysorbate 40 (polyoxyethylene (20) sorbitan monopalmitate); polysorbate 60 (polyoxyethylene (20) sorbitan monostearate); and polysorbate 80 (polyoxyethylene (20) sorbitan monooleate). The 20, 40, 60, and 80 following “polysorbate” indicate the type of fatty acid moiety (the “lipophilic tail” of the molecule) appended to the polyoxyethylene sorbitan moiety (the “hydrophilic head” of the molecule): 20 is monolaurate, 40 is monopalmitate, 60 is monostearate, and 80 is monooleate (an example of a mono-unsaturated fatty acid moiety). The “polysorbate #” names assume 20 oxyethylene moieties [that is, —(CH₂CH₂O)—] appended to the sorbate. The alternate detailed names (e.g., “polyoxyethylene (20) sorbitan monostearate”) indicate the number of oxyethylene moieties substituted on the sorbitan (20) and the fatty acid moiety appended to one of those moieties (monostearate).

In certain embodiments, the surfactant can be or can comprise one or more of polysorbate 20, polysorbate 40, polysorbate 60, and/or polysorbate 80. For instance, the surfactant can be or can comprise polysorbate 60.

Commercially available examples include Avapol™ 60K from Avatar Corporation (polysorbate 60); Tween™ 20 detergent from Sigma-Aldrich or Tween™ 20 Surfact-Amps detergent solution from Thermo Scientific™; and Tween™ 40 viscous liquid from Sigma-Aldrich (also known as food additive number E434 in the European Union).

Also or instead, a surfactant that is a variant of the particular polysorbates just described may be employed. For example, referring again to Formula I, two, three, or all of R¹-R⁴ can each be a straight chain fatty acid moiety (with the remainder of R¹-R⁴, if any, being hydrogen). An example of this class of compound includes polyoxyethylene sorbitan tristearate, in which three of R¹ to R⁴ are the fatty acid moiety stearate, and the other of R¹ to R⁴ is hydrogen.

Finally, it is reiterated that in other embodiments, sorbitan esters may be employed in a polymer composition as a PPA blend component. Referring to Formula (I), w, x, y, and z would each be 0 (meaning no oxyethylene moieties are present). An example of such a compound is sorbitan tristearate, in which x, w, y, and z are each 0; three of R¹ to R⁴ are the fatty acid moiety stearate, and the other of R¹ to R⁴ is hydrogen.

### Amounts of PPA Composition in Polymer Composition

The PPA composition (comprising PEG and optionally also surfactant per descriptions above) can be deployed in the polymer composition in amounts of at least 200 ppm, such as at least 250 ppm, at least 300 ppm, at least 400 ppm, at least 500 ppm, or at least 600 ppm. For instance, it can be deployed in an amount within a range from a low of any one of 200, 250, 300, 350, 400, 450, 500, 550, 600, 650, 700, 750, 800, 900, 950, 1000, 1100, 1200, 1250, and 1500 ppm to a high of any one of 400, 500, 600, 700, 800, 900, 1000, 1100, 1200, 1300, 1400, 1500, 1600, 1700, 1800, 1900, 2000, 2500, 3000, 3500, 4000, 4500, 5000, 7500, 10000, 12500, and 15000 ppm, with ranges from any foregoing low to any foregoing high contemplated, provided the high end is greater than the low end (e.g., 300 to 15,000 ppm, such as 300 to 2,000 ppm; or 500 to 1500 ppm, such as 500 to 1200 ppm, or 600 to 1200 ppm). The ppm values recited herein for polyethylene glycol (or PEG-based PPA composition), as well as any other additives described herein, are all based on mass of the polymer composition (i.e., inclusive of polymer plus PPA, as well as any and all other additives in the polymer composition), unless otherwise specifically noted. For instance, in the case of delivering PPA using a masterbatch, the above-noted ranges for PPA loading are inclusive of carrier resin ultimately included in the polymer composition (that is, suitable amount of masterbatch should be used such that PPA within the masterbatch, is delivered to the polymer composition within the above-described ranges). Amounts of PPA in a polymer composition can most readily be determined using mass balance principles (e.g., PPA amount is determined as mass of PPA added to a polymer composition, divided by (mass of PPA plus mass of polymer plus mass of any other additives blended together to form the polymer composition)). NMR analysis could be used to determine the PPA content of an already-mixed polymer composition (e.g., polymer pellet(s) comprising the polymer and PPA), but where there is a discrepancy between the two methods (mass balance and NMR), the mass balance method should be used.

### PPA Masterbatches

Relatively lower-molecular weight PEG (e.g., Mw of 40,000 g/mol or less, such as 20,000 g/mol or less) can present some handling challenges due to lower melting points; however, these are readily overcome by deploying the PEG-containing PPA composition as a PPA masterbatch where necessary for better handling (e.g., for delivery as a solid additive to compounding extruder in a polymer finishing process). Such masterbatches comprise the PPA composition (e.g., as described above, comprising PEG and optionally surfactant such as sorbitan ester or polysorbate) and a carrier resin. In general, a PPA masterbatch can be used as the PPA composition as described throughout the present disclosure, such that the equivalent final loading of PPA in the polymer composition is maintained. Thus, a PPA masterbatch having 4 wt % PPA composition loading can be deployed at 25,000 ppm (2.5 wt %) in a polymer composition to target 1000 ppm loading of PPA composition in the polymer composition. In general, then, a polymer composition comprising a PPA composition in accordance with the present disclosure can be formed by combining the polymer composition with a masterbatch comprising the PPA composition and carrier resin.

The carrier resin can be any suitable olefinic homopolymers or copolymer, although preferred carrier resins will be generally compatible with, or preferably of similar type to, the polymers targeted in a given production campaign. That is, for a production campaign of ethylene-based polymers, an ethylene-based carrier resin (e.g., having at least 50 wt % units derived from ethylene) is preferred. Moreover, the carrier resin is preferably relatively easy to process, i.e., having melt index (MI) of 0.8 g/10 min or greater, such as 1.0 g/10 min or greater, or 1.5 g/10 min or greater. Particular examples include polyethylene having such MI. Ethylene copolymers are suitable examples of such polyethylene, such as Ziegler-Natta or metallocene-catalyzed copolymers of ethylene and one or more of 1-butene, 1-hexene, and 1-octene, known as ZN-LLDPE or mLLDPE (respectively, Ziegler-Natta catalyzed or metallocene catalyzed linear low density polyethylene). Examples of mLLDPE include, e.g., Exceed™ performance polyethylene from ExxonMobil, such as Exceed 1018 or Exceed 2018. Other examples include Ziegler-Natta catalyzed LLDPE (ZN-LLDPE), such as copolymers of ethylene and 1-butene, 1-hexene, and/or 1-octene, as catalyzed by Ziegler Natta catalysts, such as ExxonMobil™ LL1001 LLDPEs, or others of ExxonMobil's LL series of LLDPEs. Yet further suitable examples include low density polyethylene (LDPE) as may be produced from free radical polymerization, particularly a high pressure polymerization process. Thus, in various embodiments, the carrier resin can be selected from the group consisting of mLLDPE, ZN-LLDPE, LDPE, or combinations thereof. In particular embodiments, the carrier resin can be substantially identical to the polymer of the polymer composition, meaning that it is the same grade (that is, has substantially the same monomer and (optional) comonomer content and substantially the same properties, e.g., density, melt index, MIR, comonomer distribution, branching architecture, and the like).

PPA composition loading in the masterbatch can be adjusted as needed, and the ordinarily skilled artisan will readily recognize the inverse relationship between PPA composition loading in the PPA masterbatch, and amount of masterbatch to be deployed in a polymer composition in order to achieve target PPA loading in the polymer composition (e.g., as the PPA masterbatch comprises more PPA composition, correspondingly less PPA masterbatch need be loaded into the polymer composition). For sake of illustration, example loadings of PPA composition in PPA masterbatch include PPA composition within the range from a low of 1, 2, 3, 4, or 5 wt % to a high of 5, 6, 7, 8, 9, 10, 20, 25, 30, 35, 40, 45, or 50 wt %, with ranges from any foregoing low end to any foregoing high end contemplated (provided the high end is greater than the low end). However, it is preferred to keep PPA composition loading in the masterbatch relatively lower (e.g., within the 1-20 wt % range, such as 1-10 wt %, or 2 to 7 wt %), particularly for PPA composition comprising PEG having Mw within the range from 7500 to 11,000 g/mol. Thus, a PPA masterbatch comprising 4 wt % PPA composition (on basis of mass of masterbatch) may be deployed at 2.5 wt % loading (25000 ppm), on the basis of mass of the polymer composition, to maintain 1000 ppm PPA composition loading in the polymer composition; and deployed at 5.0 wt % loading (50000 ppm), on the basis of mass of the polymer composition, to maintain 2000 ppm PPA composition loading in the polymer composition.

Finally, as discussed elsewhere herein, additional additives may be included in the polymer composition. It is contemplated that such additives may be added to the polymer composition separately from a PPA masterbatch, or as part of the PPA masterbatch.

### Methods of Introducing PPA Composition to Polymer Compositions

Methods in accordance with various embodiments include adding PPA composition (according to the above description) to a polymer composition (e.g., polymer granules and/or slurry) exiting a polymerization reactor to form a pre-finished polymer mixture in or upstream of a compounding extruder. The pre-finished polymer mixture therefore includes the polymer and PPA composition (both per above respective descriptions), as well as any optional other additives (which may be provided to the mixture along with, before, or after the PPA composition). The pre-finished polymer mixture may, for example, be a polymer melt (e.g., formed in or just upstream of a compounding extruder). The mixture is then extruded and optionally pelletized to form a further polymer composition (e.g., polymer pellets) comprising the PPA composition and polymer (each per above, and with the PPA composition in amounts in accordance with the above discussion), as well as any optional other additive(s).

Also or instead, methods may include mixing finished polymer (e.g., polymer pellets) with PPA composition to form a polymer article mixture; and processing the polymer article mixture to form a film. Such processing may be in accordance with well-known methods in the art, and in particular in accordance with blown film extrusion.

The above methods and any other methods of mixing the PEG (or PEGPPA composition with polymer to form a polymer composition as described herein, also can include adequately mixing the PPA composition into the polymer. The present inventors have surprisingly found that not all methods of mixing PPA composition may be sufficient; instead, the PPA composition should be melt blended at sufficiently high temperature and/or specific energy input (total mechanical energy forced into a polymer per unit weight, e.g., J/g, a metric for extent of mixing) with the polymer to achieve adequate homogenization among PPA composition and polymer. For instance, melt-blending such as through melting and then coextrusion of the PPA composition and polymer (e.g., in a compounding extruder) under elevated temperature (e.g., 150° C. or more, such as 200° C. or more) can achieve adequate homogenization, while simply melting the PPA composition and tumble-blending with polymer might not achieve adequate homogenization. Thus, methods of various embodiments include mixing the PPA composition and polymer (e.g., polyethylene) in a manner that ensures both components melt during the mixing (e.g., melt-mixing, coextrusion in a compound extruder). Preferred methods according to some embodiments include melt-blending and coextruding the PPA composition and polymer (and optional other additives) in a compounding extruder, and pelletizing the mixture upon its exit from the extruder, thereby locking the homogenously blended mixture in place. More specifically, such methods can include: (a) feeding a PPA composition and a polymer (e.g., polyethylene) into an extruder (optionally with other additives); (b) coextruding the PPA composition and polymer in the extruder at an elevated temperature suitable for melting both the PPA composition and the polymer (e.g., 200° C. or higher); and (c) pelletizing the extrudate to form the polymer composition comprising the PPA composition. Preferably, the extrusion is carried out under oxygen-poor atmosphere (e.g., nitrogen atmosphere).

In the above discussion, as with other discussions herein, where “PPA composition” is referenced, a masterbatch comprising PPA composition and carrier resin may be substituted therefor, as long as the relative amounts of PPA composition delivered to a polymer composition via masterbatch remain consistent with amounts of PPA composition alone that would be delivered to the polymer composition.

### Other Additives

As noted, other additives optionally can also be present in the polymer composition (e.g., antioxidants, stabilizers such as UV stabilizers, catalyst neutralizers, and other additives known in the art of polymerization). Where such additives are employed, they are also preferably free or substantially free of fluorine. Further, it is reiterated that where other additives are present, the mass of such additives is included in the denominator for determining the ppm loading amounts for PPA composition described herein (that is, the ppm loading is on the basis of total mass of polymer+PPA+other additives).

According to various embodiments, it may be advantageous to employ an additive package including antiblock and/or slip agents, potentially along with other additives. In particular as regards antiblock and slip agents, data indicate these may provide a potential advantage of quicker melt fraction elimination when employed with the PPA composition. Examples of antiblock agents are well known in the art, and include talc, crystalline and amorphous silica, nepheline syenite, diatomaceous earth, clay, or various other anti-block minerals. Particular examples include the Optibloc agents available from Mineral Technologies. Examples of slip agents for polyolefins include amides such as erucamide and other primary fatty amides like oleamide; and further include certain types of secondary (bis) fatty amides. Antiblock agent loading is often around 500 to 6000 ppm, such as 1000 to 5000 ppm; slip agent loading is typically 200 to 1000, 2000, or 3000 ppm. Other can include, for example: fillers; antioxidants (e.g., hindered phenolics such as IRGANOX™ additives available from Ciba-Geigy); phosphites (e.g., IRGAFOS™ compounds available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; release agents; anti-static agents; pigments; colorants; dyes; waxes; silica; fillers; talc; mixtures thereof, and the like.

### Films

As noted, a significant reason for employing PPAs is to eliminate melt fracture in blown films. Ideally, when replacing incumbent PPAs with the PPA composition of the present disclosure, films made from polymer compositions including such PPA composition will exhibit similar or superior properties as compared to films made using polymer compositions comprising conventional PPA.

Thus, the invention of the present disclosure can also be embodied in a film made from any of the above-described polymer compositions (and in particular, polyethylene compositions) comprising the polymer and 250 to 15000 ppm (such as 250 to 11000 ppm) of the PPA composition (e.g., such that PEG(s) in the PPA have Mw less than 40,000 g/mol, such as within the range from 3000, 4000, 5000, 6000, or 7500 g/mol to 11000, 15000, 20000, or 35000 g/mol), and preferably being free or substantially free of fluorine; wherein the film has one or more of (and preferably all of):
1% secant modulus (MD) within +/−5% psi, preferably within +/−1% psi, of the value (psi) of a film that is made using a fluoropolymer-based PPA instead of the PPA composition, but is otherwise identical;
Elmendorf tear (MD) within +/−10% g, preferably within +/−5% g, of the value (g) of a film that is made using a fluoropolymer-based PPA instead of the PPA composition, but is otherwise identical;
Total haze within +/−25%, preferably within +/−10%, of the value (in %) of a film that is made using a fluoropolymer-based PPA instead of the PPA composition, but is otherwise identical, and/or total haze less than 6%;
Gloss (MD) within +/−12%, preferably within +/−10%, of the value (in GU) of a film that is made using a fluoropolymer-based PPA instead of the PPA composition, but is otherwise identical; and
Dart within +/−1%, preferably within +/−0.5% or even within +/−0.1%, of the value (g) of a film that is made using a fluoropolymer-based PPA instead of the PPA composition, but is otherwise identical.

Where the PPA composition includes a PPA blend partner (e.g., metal salt of a fatty acid, such as zinc stearate), the amounts (in ppm) of PPA composition still apply, but within those amounts (e.g., within the 250 to 15000 ppm), the PEG and PPA blend partner are present in a weight ratio of 30:70 to 70:30 (PEG:PPA blend partner), and preferably are present at a 1:1 ratio (e.g., such that 1000 ppm PPA composition of such embodiments equates to 500 ppm PEG and 500 ppm PPA blend partner).

Further, in the discussion above, a film “made using a fluoropolymer-based PPA instead of the PPA composition, but is otherwise identical” is intended to mean that a film made using an effective amount of PPA composition is compared against a film made using an effective amount of fluoropolymer-based PPA; not necessarily that the same amount of each PPA is used. An effective amount is such that visible melt fractures are eliminated from the film, consistent with the discussion in connection with Example 1.

### EXAMPLES

To facilitate a better understanding of the embodiments of the present invention, the following examples of preferred or representative embodiments are given.

### Example 1

Blown film trials were conducted on a blown film extruder line L2 with extruder and die characteristics, conditions, and temperature profile per Table 1 below.

TABLE 1
L2 Extruder and Die Processing Conditions

| | | | |
|---|---|---|---|
| Die diameter (in.): | 2 | Forming cone (turns out): | 1 |
| Die gap (mil): | 30 | Zone 1 temp. (F.): | 310 |
| Mass air ring height (in): | 0.250 | Zone 2 temp. (F.): | 410 |
| Chimney height (in): | 0.875 | Zone 3 temp. (F.): | 380 |
| Gauge (mil): | 2-5 mil | Zone 4 temp. (F.): | 350 |
| BUR: | 2.5 | Screen changer temp. (F.): | 360 |
| Frostline height (in): | 10 | Adapter temp. (F.): | 360 |
| Die factor (lbs/hr-in): | — | Block zone temp. (F.): | 360 |
| Output (lbs/hr): | 25 | Die zones 1&2 temp. (F.): | 390 |
| Line Speed (ft/min): | — | Target melt temp. (F.): | 390 |

Multiple films were made using different samples of the same commercial Ziegler-Natta catalyzed polyethylene resin (LL1001 LLDPE from ExxonMobil Product Solutions Company, an ethylene-1-butene copolymer). Nominally, each sample of the LL1001 LLDPE resin would have MI of 1.0 g/10 min (190° C., 2.16 kg) and density of 0.918 g/cm³.

However, due to expected variations in measurement conditions and the nature of the properties measured, some deviations were observed in each sample of the LL1001 LLDPE resin among the different formulations tested. Therefore, Table 2 below reports the specifically measured density, MI, HLMI, and MIR for each sample, along with the PPA composition, for each formulation used in making film samples per this example. For PPA compositions in Table 2: “Dynamar” is Dynamar™ FX5929M, an incumbent fluoropolymer-containing PPA; “Pluriol” is Pluriol® E 8000, a PEG having Mw of about 8,000 g/mol; Avapol is Avapol™ 60K from Avatar Corporation; and ZnSt is a zinc stearate composition (an example of a metal salt of a fatty acid)). In addition to the compounds listed in Table 2, each trial formulation also included 500 ppm IRGANOX™ 1076 hindered phenolic anti-oxidant; 1000 ppm IRGAFOS™ 168 phosphite from Ciba-Geigy; and 300 ppm zinc oxide (acid neutralizer).

TABLE 2
PPA formulations and LL1001 properties for each trial run

| | | LL1001 Properties | | | |
|---|---|---|---|---|---|
| ID | Formulation | Density | MI | HLMI | MIR |
| C-1 | LL1001 + Dynamar 400 ppm | 0.919 | 0.88 | 23.0 | 26.2 |
| I-1 | LL1001 + PEG/Avapol, 800/200 ppm | 0.919 | 0.90 | 22.3 | 24.9 |
| I-2 | LL1001 + PEG/Avapol, 800/400 ppm | 0.919 | 0.94 | 22.7 | 24.2 |
| I-3 | LL1001 + PEG/Avapol, 800/800 ppm | 0.919 | 0.91 | 22.5 | 24.8 |
| I-4 | LL1001 + PEG/Avapol, 400/800 ppm | 0.920 | 0.89 | 22.8 | 25.5 |
| I-5 | LL1001 + ZnSt/PEG, 800/200 ppm | 0.919 | 0.92 | 23.7 | 25.8 |
| I-6 | LL1001 + ZnSt/PEG, 800/400 ppm | 0.919 | 0.93 | 24.2 | 26.0 |
| I-7 | LL1001 + ZnSt/PEG, 800/800 ppm | 0.918 | 0.92 | 24.0 | 26.0 |
| I-8 | LL1001 + ZnSt/PEG, 400/800 ppm | 0.919 | 0.90 | 23.2 | 25.9 |
| I-9 | LL1001 + PEG, 500 ppm | 0.919 | 0.90 | 23.4 | 26.1 |
| I-10 | LL1001 + PEG, 750 ppm | 0.919 | 0.89 | 23.5 | 26.4 |
| I-11 | LL1001 + PEG, 1000 ppm | 0.919 | 0.87 | 23.9 | 27.4 |
| I-12 | LL1001 + PEG, 1200 ppm | 0.919 | 0.93 | 23.5 | 25.3 |
| I-13 | LL1001 + Avapol, 500 ppm | 0.919 | 0.91 | 23.1 | 25.4 |
| I-14 | LL1001 + Avapol, 750 ppm | 0.918 | 0.90 | 23.3 | 25.9 |
| I-15 | LL1001 + Avapol, 1000 ppm | 0.919 | 0.90 | 22.8 | 25.4 |
| I-16 | LL1001 + Avapol, 1200 ppm | 0.919 | 0.91 | 23.2 | 25.5 |

The same general process was used for film production for each trial run in order to investigate the elimination of melt fracture using different PPMs on each PE resin; extruder die pressure experienced for each PPA was also recorded and analyzed. More particularly, the process was as follows:
Run extruder with a 2:1 blend of purge resin: Polybatch® KC 30. Continue until clean, about 30 min. The Purge resin used in this preliminary cleaning step for each trial is a PPA-free version of the same polyethylene (LL1001 LLDPE) used for film production for the given trial. The purge resin did contain the same 500 ppm IRGANOX™ 1076, 1000 ppm IRGAFOS™ 168, and 300 ppm ZnO as used in all other formulations.
Manually clean and polish inner die with polishing paste (Improved Old Purpose Mold Polish by IMS Company).
Run purge resin until KC30 is gone and melt fracture is steady, about 45 min. Typical purge resin rates were 2-3 lbs/hr to obtain steady melt-fracture free film product.
Set test timer to 0. Feed test resin (resin plus PPA Blend being tested) at target output rate. Adjust rpm to get target output within the first 15 min.
Every 15 min: take 2 ft. film sample and label w/test resin, date & collection time, record run data on table.
Run until whichever comes first: melt fracture is eliminated or 105 minutes.

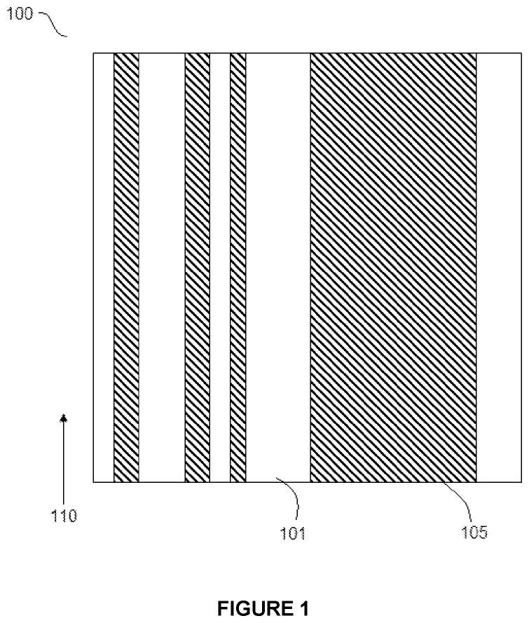

As the PPA-containing resin of each trial was fed, the melt fractures slowly began to disappear in streaks as illustrated in FIG. 1. With reference to FIG. 1, as the PPA is added, melt fracture-free regimes begin to emerge as stripes 101 in the machine direction 110 of the film 100 (that is, the direction in which the film is extruded and blown). FIG. 1 is a schematic conceptually illustrating this transitory period with streaks 105 of melt-fractured film material, and the stripes 101 of melt fracture-free film. Over time, these stripes 101 grow in width and the melt fracture zones diminish, and, ideally, will eventually be eliminated completely. As noted, for these Example 1 trials, a 2 ft sample of film was obtained every 15 minutes for visual inspection to determine the % of melt fracture remaining in the film at the given 15-minute interval. Where melt fracture was completely eliminated between one sampling and the next (e.g., between the 45-minute and the 60-minute sample), elimination is reported at the mid-point between the samplings, rounded down (e.g., for the given 45- and 60-min example, recorded as 52 min).

The results from the Example 1 trials are summarized in Table 3 below, which reports the following for each trial run: the amounts and ratios of components in each PPA blend; total PPA used; melt fracture observed at 105 min (MF @ 105 min) as a % of film area containing visible melt fractures; time to melt fracture elimination (MFE) in min; operating pressure at the extrusion die (psi); die factor; and specific output. Operating pressure provides an additional performance metric to track, insofar as a lower operating pressure is generally better (indicating greater ease of processing). In this experiment, operating pressure is taken as the final pressure at the end of the test (end time if melt fracture persisted, or the time at which complete melt fracture elimination was observed). Specific Output is the output of film (defined as lb/hr divided by extruder speed (rpm)), and die factor is the output (lb/hr) divided by die circumference (in).

TABLE 3
Films Made using LL1001 LLDPE and Trial PPA compositions

| | | | MF @ | Time | | | Specific |
|---|---|---|---|---|---|---|---|
| | | PPA | 105 min | to MFE | Pressure | Die factor | output |
| ID | PPA | (ppm) | (%) | (min) | (psi) | (lbs/hr-in die) | (lbs/hr-rpm) |
| C-1 | Dynamar | 400 | 15 | N/A | 3710 | 3.2 | 1.1 |
| I-1 | PEG/Avapol | 800/200 | 4.2 | N/A | 3845 | 4.2 | 1.5 |
| I-2 | PEG/Avapol | 800/400 | 0.9 | N/A | 3760 | 4.1 | 1.4 |
| I-3 | PEG/Avapol | 800/800 | 1.1 | N/A | 3475 | 4.2 | 1.5 |
| I-4 | PEG/Avapol | 400/800 | 2 | N/A | 3970 | 4.2 | 1.5 |
| I-5 | ZnSt/PEG | 800/200 | 100 | N/A | 4290 | 3.9 | 1.4 |
| I-6 | ZnSt/PEG | 800/400 | 100 | N/A | 4190 | 3.9 | 1.4 |
| I-7 | ZnSt/PEG | 800/800 | 100 | N/A | 4200 | 3.9 | 1.4 |
| I-8 | ZnSt/PEG | 400/800 | 100 | N/A | 4170 | 3.9 | 1.4 |
| I-9 | PEG | 500 | 92 | N/A | 4185 | 4 | 1.4 |
| I-10 | PEG | 750 | 15 | N/A | 4105 | 4.1 | 1.4 |
| I-11 | PEG | 1000 | 6 | N/A | 3900 | 3.6 | 1.2 |
| I-12 | PEG | 1200 | 8 | N/A | 3840 | 3.6 | 1.2 |
| I-13 | Avapol | 500 | 100 | N/A | 4290 | 3.9 | 1.4 |
| I-14 | Avapol | 750 | 100 | N/A | 4260 | 3.9 | 1.4 |
| I-15 | Avapol | 1000 | 100 | N/A | 4270 | 4 | 1.4 |
| I-16 | Avapol | 1200 | 99.8 | N/A | 4285 | 4 | 1.4 |

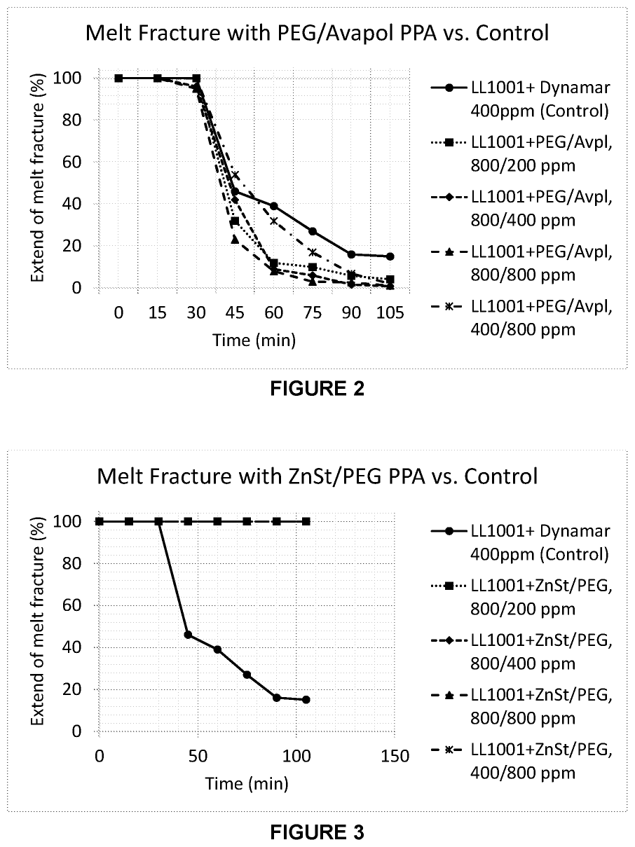

FIG. 2 is a graphical illustration of the observed melt fracture % over time for the PEG/Avapol films of Table 3 (I-1 through 1-4) vs. the control, illustrating the rate at which melt fractions were eliminated by each trial PPA composition. FIG. 2 shows superior performance among all blends of PEG and Avapol as compared to the incumbent formulation, indicating that a PPA comprising a blend of PEG and polysorbate is a highly promising candidate for the ZN-catalyzed LLDPE. While melt fractures were not completely eliminated during the 105-minute trial, the clear downward trend in melt fractures indicates a high likelihood that the PEG/Avapol blend PPA would have eliminated melt fracture with a few additional minutes of runtime.

FIG. 3 is a graphical illustration of the observed melt fracture % over time for the ZnSt/PEG films of Table 3 (I-5 through I-8) vs. the control, illustrating the rate at which melt fractions were eliminated by each of these trial PPA compositions. FIG. 3 shows that the ZnSt/PEG-based PPA was not an effective PPA at any level of loading, as it did not achieve melt fracture elimination in any of the samples. Thus, such a PPA is likely not a promising candidate for the ZN-catalyzed LLDPE.

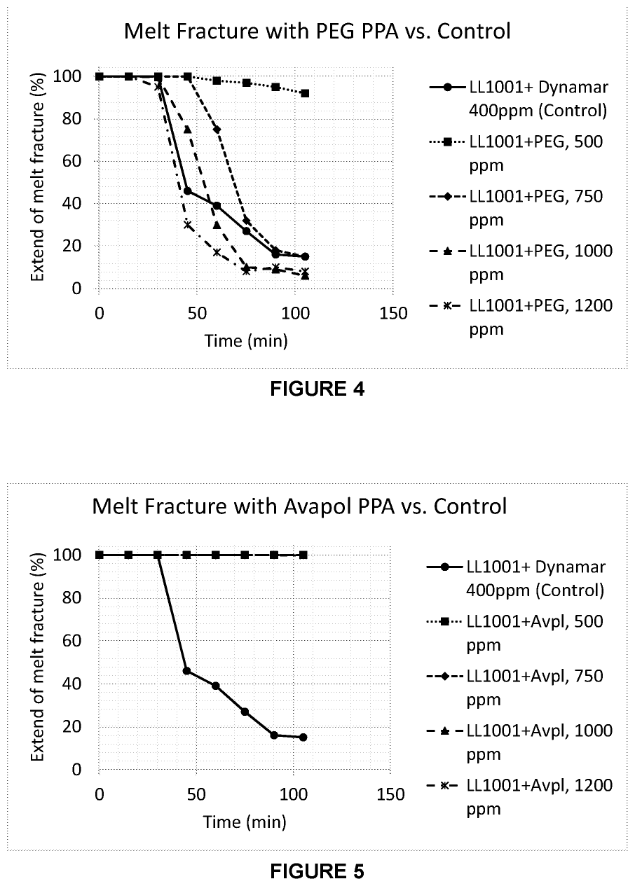

FIG. 4 is a graphical illustration of the observed melt fracture % over time for the PEG films of Table 3 (I-9 through I-12) vs. the control, illustrating the rate at which melt fractions were eliminated by each of these trial PPA compositions. FIG. 4 shows that with sufficiently high amounts of PEG (e.g. over 500 ppm, such as 750 ppm and higher), melt fractures are eliminated to an equal or greater extent than with the incumbent PPA, although substantial amounts of melt fracture remained in all cases (including with use of the incumbent). Thus, PEG alone is a potentially promising PPA, but in comparison with FIG. 2 (I-1 through I-4, using PEG/Avapol blend as PPA), this indicates substantial synergistic effects with the PEG/Avapol combination.

FIG. 5 is a graphical illustration of the observed melt fracture % over time for the Avapol films of Table 3, illustrating the rate at which melt fractions were eliminated by each of these trial PPA compositions. FIG. 5 shows that Avapol alone was not an effective PPA at any level of loading in the ZN-catalyzed LLDPE, which further indicates the synergy obtained with Avapol (polysorbate) and PEG blended together and employed as PPA in ZN-catalyzed LLDPE, per FIG. 2 (I-1 through I-4) above.

### Example 2

Data from a similar set of trial runs on the same blown film extruder line are presented below in Table 4 (which is a partial reproduction from Table 1 of application Ser. No. U.S. 63/309,859), noting that instead of the Ziegler Natta-catalyzed LL1001 LLDPE, a metallocene-catalyzed LLDPE (Exceed™ 1018, from ExxonMobil Product Solutions Company) was utilized. Otherwise, the processing conditions and procedure for running each trial film was the same as in Example 1; and the same procedure for assessing melt fracture elimination as used in the Example 1 trials was also employed, except that the trial was carried out for 100 min, and melt fracture was observed visually on the film during production for closer estimation of the time at which melt fracture was eliminated. It is noted that, due to the nature of the assessment, it is understood that reported times to melt fracture elimination may have room for +/−2 to 5 minutes of error. This, however, does not undercut the ultimate conclusions regarding comparative melt fracture elimination across these trials, and the data further serves as an additional useful comparator vs. the trials of Example 1.

For all trials in Table 4, PEG 8K is used as the PPA, except that the “reference” of example C2 is the same Dynamar PPA used in Example 1. Further, the C2 reference was run for some additional time past 100 min to confirm elimination of melt fracture.

TABLE 4
PEG 8K employed as PPA for Exceed ™ 1018 mLLDPE

| | | Melt- | Time to | Final | | |
|---|---|---|---|---|---|---|
| | | fract @ | Melt fract. | extruder | | Specific |
| | | 100 min | elimination | pressure | Die factor | output |
| ID | PPA | (%) | (min) | (psi) | (lbs/hr-in die) | (lbs/hr-rpm) |
| C2 | 400 ppm reference | 0 | 103 | 4080 | 2.9 | 1.1 |
| I17 | 250 ppm PEG 8K | 2 | N/A | 4860 | 3.6 | 1.3 |
| I18 | 500 ppm PEG 8K | 0 | 42 | 4745 | 2.8 | 1 |
| I19 | 750 ppm PEG 8K | 0 | 85 | 4650 | 2.9 | 1.1 |
| I20 | 1000 ppm PEG 8K | 0 | 61 | 4800 | 2.9 | 1.1 |

Likewise, Table 5 below is a partial reproduction of data from Table 6 of U.S. 63/309,589, which employed Dynamar (“reference”) and PEG 8K as the PPA for a different mLLDPE (slightly branched, 0.923 g/cm³ density mLLDPE with 0.48 MI and 40 MIR).

TABLE 5
PEG 8K employed as PPA for mLLDPE with slightly branched architecture

| | | Melt- | Time to | Final | | |
|---|---|---|---|---|---|---|
| | | fract @ | Melt fract. | extruder | | Specific |
| | | 100 min | elimination | pressure | Die factor | output |
| ID | PPA | (%) | (min) | (psi) | (lbs/hr-in die) | (lbs/hr-rpm) |
| C3 | 500 ppm reference | 0 | 52 | 4800 | 3.9 | 1.1 |
| I21 | 500 ppm PEG 8K | 0 | 50 | 4890 | 3.9 | 1.1 |
| I22 | 750 ppm PEG 8K | 0 | 37 | 4850 | 3.8 | 1.1 |
| I23 | 1000 ppm PEG 8K | 0 | 37 | 4815 | 3.7 | 1 |

### Example 3

Finally, below in Tables 6 and 7, data from Tables 2-1 and 3-1, respectively, of U.S. Application Ser. No. 63/366,678 are partially reproduced, showing (Table 6) blends of PEG 8K/Polysorbate 60 (same Avapol™ 60K from Avatar Corporation as used in Example 1) employed as PPA for Exceed™ 1018 mLLDPE, and (Table 7) blends of ZnSt/PEG 8K (same zinc stearate as used in Example 1) employed as PPA for Exceed™ 1018 mLLDPE.

TABLE 6
PEG 8K and Polysorbate 60 employed as PPA for Exceed ™ 1018 mLLDPE

| | | | Time | | | Specific |
|---|---|---|---|---|---|---|
| | PEG/Avpl | MF@105 | to MFE | Pressure | Die factor | output |
| ID | (ppm/ppm) | min (%) | (min) | (psi) | (lbs/hr-in die) | (lbs/hr-rpm) |
| C-1 | n/a (400 ppm | 0 | ~102* | 4080 | 3.9 | 1.5 |
| | Dynamar) | | | | | |
| I-1 | 400/400 | 0 | 52 | 4360 | 4.1 | 1.4 |
| I-2 | 800/800 | 0 | 52 | 4010 | 4.2 | 1.5 |
| I-3 | 800/400 | 0 | 82 | 4320 | 4.0 | 1.4 |
| I-4 | 400/800 | 0.1 | N/A | 3735 | 3.5 | 1.4 |
| I-5 | 800/200 | 0 | 82 | 3830 | 4.2 | 1.5 |
| I-6 | 650/325 | 0 | 37 | 4270 | 4.2 | 1.4 |
| I-7 | 430/220 | 0.2 | N/A | 4460 | 4.2 | 1.6 |

*C-1 melt fracture almost, but not entirely, observed to be eliminated by 100 min. Final melt fracture eliminated between 100 and 105 min, hence elimination is reported as 102 min, the mid-point rounded down for consistency with other reported MFE times.

TABLE 7
ZnSt and PEG 8K employed as PPA for Exceed ™ 1018 mLLDPE

| | | | Time | | | Specific |
|---|---|---|---|---|---|---|
| | ZnSt/PEG | MF@105 | to MFE | Pressure | Die factor | output |
| ID | (ppm/ppm) | min (%) | (min) | (psi) | (lbs/hr-in die) | (lbs/hr-rpm) |
| C-1 | n/a (400 ppm | 0 | 102 | 4080 | 3.9 | 1.5 |
| | Dynamar) | | | | | |
| I-15 | 400/400 | 15 | N/A | 5325 | 4.1 | 1.4 |
| I-16 | 800/800 | 0 | 52 | 5070 | 4.1 | 1.4 |
| I-17 | 800/400 | 0 | 37 | 5175 | 4.1 | 1.4 |
| I-18 | 400/800 | 0.04 | N/A | 4560 | 4.1 | 1.4 |
| I-19 | 800/200 | 8.5 | N/A | 5175 | 3.9 | 1.4 |
| I-20 | 650/325 | 10 | N/A | 5260 | 4.1 | 1.4 |
| I-21 | 430/220 | 50 | N/A | 5230 | 4.1 | 1.4 |

### Discussion

The PEG/polysorbate PPA (PEG and Avapol™ 60K) was by far the most successful candidate PPA for the Ziegler Natta-catalyzed LLDPE, outperforming the incumbent and all other tested PPA formulations in the ZN-catalyzed LLDPE. Interestingly, this includes outperformance of PEG alone (which achieved decent, but still inferior, melt fracture elimination, more closely tracking the incumbent PPA); and substantial outperformance of polysorbate alone (which did not even achieve noticeable melt fracture elimination during the course of the trials), as well as of the blend of ZnSt and PEG. This indicates a likely synergy achieved with a blend of PEG and polysorbate utilized as a PPA in ZN-catalyzed LLDPE.

That said, the promise of PEG alone as a PPA (including masterbatches thereof) should not be overlooked, given that it performed on-par or better than the incumbent fluoropolymer-containing PPA. Achieving equal or greater performance with a fluorine-free PPA, alone, brings substantial improvement over the previous state of the art. This promise is even greater when the PEG is combined with polysorbate (e.g., the Avapol™ 60K from Avatar Corporation).

The results are even more interesting when viewed in comparison to the data for similar PPAs employed with metallocene-catalyzed LLDPEs per Examples 2 and 3. PEG, ZnSt/PEG, and PEG/Avapol™ 60K all performed acceptably well (at adequate loadings) in eliminating melt fracture in mLLDPE with similar MI and density as the Ziegler-Natta-catalyzed LL1001 LLDPE. The data highlights the potential for selecting PPA based upon the properties of the polymer to which it is deployed; although it additionally highlights the versatility of PEG, and particularly PEG 8K, as a fluorine-free PPA for use across various different LLDPE grades (including both ZN and metallocene-catalyzed); with optional addition of polysorbate as a blend partner where desired (e.g., for faster melt fracture elimination in films made using a ZN-LLDPE).

### Test Methods

Table 8 below reports the test methods used in connection with the Examples. Unless stated otherwise in the description of a given property, these methods are also to be used in determining properties in accordance with embodiments described herein.

TABLE 8
Measurement methods.

| Test Name or Parameter Name | Method or description |
|---|---|
| Melt index, high load melt index | ASTM D-1238 2.16 kg (melt index) or 21.6 kg (high load melt index), 190° C. |
| Melt index ratio | High load melt index/melt index |
| Density | ASTM D1505, column density. Samples were molded under ASTM D4703-10a, |
| | Procedure C, then conditioned under ASTM D618-08 (23° ± 2° C. and 50 ± 10% |
| | relative humidity) for 40 hours before testing |
| Percent melt fracture coverage | Measured by eye. The fraction of melt fracture Estimated visually from a 2-ft |
| | long sample of film, taken as a percentage of the area with noticeable, |
| | characteristic melt fracture roughness. Clear delineation existed between the |
| | melt fractured regions and the smooth, melt fracture free regions of the sample. |
| Pressure | Read off the in-line calibrated pressure transducer of the blown film line |
| | extruder, before the screen-pack, and recorded. |
| Die factor | Output (lb/hr) die circumference (in). Output (lb/hr) = film sample weight (g, |
| | determined from a sample as measured on a tared, calibrated weight scale) × |
| | line speed (fpm, determined from an in-line tachometer) ÷ film sample length |
| | (in, measured by yard stick) × 1.59 lb-in-min/g-ft-hr |
| Specific output | Output (lb/hr)/extruder speed (rpm). Output is computed as with die factor. |
| | Extruder speed measured by in-line tachometer. |
| PEG composition by NMR | 1 H NMR experiments were run on a 700 MHz Bruker AvanceTM IIIHD |
| | equipped with a 10 mm high temperature dual channel cryoprobe. Samples |
| | were prepped at 140° C. with around 90mg of sample per 3 ml of 1,1,2,2- |
| | tetrachloroethane-d2. Samples were measured using a 30° pulse or less, with |
| | 512 transients, a 15 second delay and a temperature of 120° C. The 15 second |
| | delay was determined to be needed for accurate quantitative 1 H NMR, The |
| | inversion recovery pulse sequence was used to measure T1 with a 20 second |
| | delay in between. The variable delay ranged from 1 millisecond to 5 seconds. |
| | Once the delay time was determined, samples with ranges of PEG from 0- |
| | 1800 ppm were measured using the quantitative 1 H NMR conditions. Fits to |
| | determine T1 were performed using MestReNova 14.0.1. The signal area used |
| | for quantification was 3.8-3.5 ppm. |

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

While the present disclosure has been described with respect to a number of embodiments and examples, those skilled in the art, having the benefit of this disclosure, will appreciate that other embodiments can be devised which do not depart from the scope and spirit of the present disclosure.

1. A polymer composition comprising:
a Ziegler-Natta catalyzed C₂-C₆ olefin homopolymer or a Ziegler-Natta catalyzed copolymer of two or more C₂-C₂₀ α-olefins; and
from 250 to 5000 ppm (on the basis of mass of the polymer composition) of a polymer processing aid (PPA) composition comprising one or more polyethylene glycols;
wherein all polyethylene glycol of the polymer composition has weight average molecular weight (Mw) less than 40,000 g/mol; and
wherein the polymer composition is substantially free of fluorine.

2. The polymer composition of claim 1, wherein the homopolymer or copolymer is an ethylene homopolymer or copolymer and has one or more of the following properties:
(a) Density within the range from 0.905 to 0.945 g/cm³;
(b) Melt index (MI, 190° C. and 2.16 kg) within the range from 0.1 to 5.0 g/10 min;
(c) Melt index ratio (MIR, ratio of high load melt index (HLMI, 190° C. and 21.6 kg) to MI) of 20 or greater; and
(d) Molecular weight distribution (Mw/Mn) within the range from 3.5 to 7.5.

3. The polymer composition of claim 2, wherein the homopolymer or copolymer has all of the properties (a)-(d).

4. The polymer composition of claim 1, wherein the polymer composition comprises a Ziegler-Natta catalyzed copolymer of ethylene and a C₃ to C₁₂ α-olefin.

5. The polymer composition of claim 4, wherein the C₃ to C₁₂ α-olefin is 1-butene.

6. The polymer composition of claim 1, comprising from 500 to 2000 ppm of the PPA composition.

7. The polymer composition of claim 1, wherein each polyethylene glycol of the polymer composition has Mw within the range from 1,500 to 35,000 g/mol.

8. The polymer composition of claim 7, wherein each polyethylene glycol of the polymer composition has Mw within the range 5,000 to 12,000 g/mol.

9. The polymer composition of claim 1, wherein the PPA composition further comprises polysorbate having the structural formula (I): 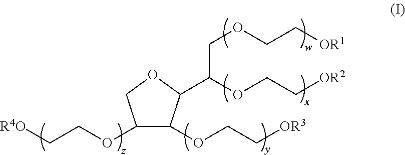
where one of R¹-R⁴ is a straight chain fatty acid moiety, and the other three of R¹-R⁴ are each hydrogen; and w, x, y, and z are integers such that 10≤w+x+y+z≤40.

10. The polymer composition of claim 9, wherein the polysorbate is polysorbate 20, polysorbate 40, polysorbate 60, polysorbate 80, or combinations thereof.

11. The polymer composition of claim 9, wherein the ratio (by mass) of the amount of polyethylene glycol to the amount of polysorbate in the polymer composition is within the range from 30:70 to 70:30.

12. The polymer composition of claim 11, wherein the ratio (by mass) of the amount of polyethylene glycol to the amount of polysorbate in the polymer composition is within the range from 40:60 to 60:40.

13. The polymer composition of claim 1, wherein the polymer composition is formed by combining the homopolymer or copolymer with a masterbatch comprising the PPA composition and a carrier resin, such that the polymer composition further comprises the carrier resin.

14. The polymer composition of claim 13, wherein the carrier resin is selected from the group consisting of metallocene-catalyzed linear low density polyethylene (LLDPE), Ziegler Natta-catalyzed LLDPE, low density polyethylene (LDPE), and combinations thereof.

15. The polymer composition of claim 13, wherein the carrier resin is substantially identical to the homopolymer or copolymer.

16. The polymer composition of claim 1, wherein the PPA composition consists essentially of either (i) the one or more polyethylene glycols or (ii) a masterbatch consisting essentially of a carrier resin and the one or more polyethylene glycols.

17. The polymer composition of claim 1, wherein the PPA composition consists essentially of either (i) the one or more polyethylene glycols and one or more polysorbates or (ii) a masterbatch consisting essentially of a carrier resin, the one or more polyethylene glycols, and one or more polysorbates;
wherein the polysorbate has the structural formula (I): 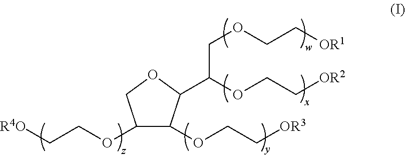
where one of R¹-R⁴ is a straight chain fatty acid moiety, and the other three of R¹-R⁴ are each hydrogen; and w, x, y, and z are integers such that 10≤w+x+y+z≤40.
